(19) United States
(12) Patent Application Publication
(10) Pub. No.: US 2012/0150898 A1
(43) Pub. Date: Jun. 14, 2012

(54) Dynamic Collection Of System Support Files In A Data Processing Environment

(75) Inventors: Eric R. Larese, Rochester, MN (US); Mario J. Lorenzo, Miami, FL (US); John E. McGinn, Rochester, MN (US)

(73) Assignee: INTERNATIONAL BUSINESS MACHINES CORPORATION, ARMONK, NY (US)

(21) Appl. No.: 12/964,324

(22) Filed: Dec. 9, 2010

(51) Int. Cl. G06F 17/30

(52) U.S. Cl. 707/769; 707/E17.014

(57) ABSTRACT

Dynamic collection of system support files in a data processing environment, the data processing environment comprising a plurality of computing systems having different characteristics, including: querying, by a support manager plugin of a management module, a registry of extensions for a support file type provider extension; presenting, by the support manager plugin to a user, a list of types of system support files available from the particular computing system; receiving, by the support manager plugin, a user selection of a type of system support file to retrieve from the particular computing system; querying, by the support manager plugin, the registry of extensions for a data collector extension; and retrieving, by the support manager plugin, the system support file from the particular computing system, including executing the data collection operation specified in the identified data collector extension.

### BACKGROUND OF THE INVENTION

1. Field of the Invention

The field of the invention is data processing, or, more specifically, methods, apparatus, and products for dynamic collection of system support files in a data processing environment.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

In modern data centers, there are many computers and frequently many different types of computers. System support tools need to be able to acquire support files from all of the different types of computers. The different types of computers, however, produce different types of support files and calls to acquire or dump the system support file contents from the different types of computers in a data center all differ according to type. As such, determining, for any particular type of computer, which support files are available from the computer, what options are available or required to be provided to acquire the system support file, and how to obtain any particular support file is often a difficult task.

### SUMMARY OF THE INVENTION

Methods, apparatus, and products for dynamic collection of system support files in a data processing environment, the data processing environment including a plurality of computing systems, a plurality of the computing systems having different characteristics, including: querying, by a support manager plugin of a management module, a registry of extensions with characteristics describing a particular computing system from which to retrieve one or more system support files for a support file type provider extension, each support file type provider extension specifying one or more types of system support files available for retrieval from computing systems having a predefined set of characteristics; presenting, by the support manager plugin to a user, a list of types of system support files available from the particular computing system; receiving, by the support manager plugin, a user selection of a type of system support file to retrieve from the particular computing system; querying, by the support manager plugin, the registry of extensions with the characteristics of the particular computing system and the selected support file type for a data collector extension, each data collector extension including a specification of a data collection operation to retrieve the system support file from the particular computing system; and retrieving, by the support manager plugin, the system support file from the particular computing system, including executing the data collection operation specified in the identified data collector extension.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example system management server useful in dynamic collection of system support files in a data processing environment according to embodiments of the present invention.

FIG. 2 sets forth a flow chart illustrating an example method for dynamic collection of system support files in a data processing environment according to embodiments of the present invention.

FIG. 3 sets forth a flow chart illustrating a further example method for dynamic collection of system support files in a data processing environment according to embodiments of the present invention.

FIG. 4 sets forth a flow chart illustrating an example method for loading, by a plugin manager, the support manager plugin for execution in the management module.

FIG. 5 sets forth a flow chart illustrating a further example method for dynamic collection of system support files in a data processing environment according to embodiments of the present invention.

### DETAILED DESCRIPTION OF EXAMPLE EMBODIMENTS

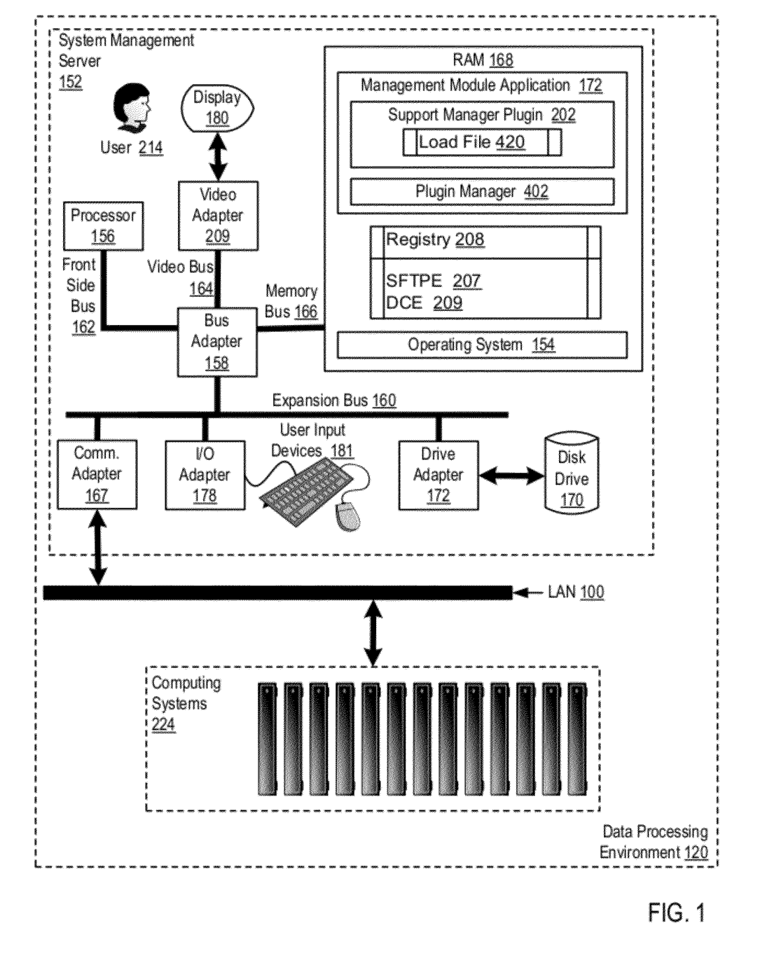

Example methods, apparatus, and products for dynamic collection of system support files in a data processing environment in accordance with the present invention are described with reference to the accompanying drawings, beginning with FIG. 1. Dynamic collection of system support files in a data processing environment in accordance with the present invention is generally implemented with computers, that is, with automated computing machinery. For further explanation, therefore, FIG. 1 sets forth a block diagram of automated computing machinery comprising an example system management server (152) useful in dynamic collection of system support files in a data processing environment according to embodiments of the present invention. The system management server (152) of FIG. 1 includes at least one computer processor (156) or ‘CPU’ as well as random access memory (168) (RAM') which is connected through a high speed memory bus (166) and bus adapter (158) to processor (156) and to other components of the system management server (152).

Stored in RAM (168) is a management module application (172), a module of computer program instructions for monitoring computing systems (224). The management module application (172) may include computer program instructions for monitoring, for example, the amount of power being consumed by the computing systems (224), the number of jobs being serviced by each of the computing systems (224) per unit of time, the amount of data communications traffic flowing into and out of the computing systems (224), errors conditions within the computing systems (224), the health of individual components within each of the computing systems (224), and so on.

The management module application (172) of FIG. 1 includes a support manager plugin (202), a module of computer program instructions for providing specific capabilities and functionality to the management module (200). The support manager plugin (202) may include computer program instructions that enable the management module application (172) to determine what type of support information, such as an error log, a core dump, or other support information is available from a computing system (224) that is being monitored by the management module application (172).

The management module application (172) of FIG. 1 also includes a plugin manager (402), a module of computer program instructions for installing, uninstalling, and monitoring plugins of the management module application (172), including the support manager plugin (202). Also stored in RAM (168) is a registry (208) of extensions. In the example of FIG. 1, the registry (208) of extensions is a data structure such as, for example, a table, a list, or other data structure that includes one or more extensions. The registry (208) includes a support file type provider extension (207). A support file type provider extension (207) represents a specification of a computing system (224) characteristics—that is, types of computing systems—along with an identification of types of system support files that may be generated by computing systems (224) having the characteristics specified in the support file type provider extension. That is, support files that can be retrieved by the management module application (172) for use in monitoring a computing system (224) of the type specified in the support file type provider extension (207).

In the example of FIG. 1, the server management system (152) carries out dynamic collection of system support files in a data processing environment (120). The data processing environment (120) includes a plurality of computing systems (224) having different characteristics. The server management system (152) carries out dynamic collection of system support files in a data processing environment (120) by querying, by the support manager plugin (202) of the management module application (172), the registry (208) of extensions with characteristics describing a particular computing system from which to retrieve one or more system support files for a support file type provider extension, each support file type provider extension comprising one or more types of system support files available for retrieval from computing systems having a predefined set of characteristics; presenting, by the support manager plugin (202) to a user (214), a list of types of system support files available from the particular computing system; receiving, by the support manager plugin (202), a user selection of a type of system support file to retrieve from the particular computing system; querying, by the support manager plugin (202), the registry (208) of extensions with the characteristics of the particular computing system and the selected support file type for a data collector extension, each data collector extension comprising a specification of a data collection operation to retrieve the system support file from the particular computing system; and retrieving, by the support manager plugin (202), the system support file from the particular computing system, including executing the data collection operation specified in the identified data collector extension.

Also stored in RAM (168) is an operating system (154). Operating systems useful in dynamic collection of system support files in a data processing environment according to embodiments of the present invention include UNIX™, Linux™, Windows XP™, AIX™, IBM's i5/OS™, and others as will occur to those of skill in the art. The operating system (154), management module application (172), and registry (208) of extensions in the example of FIG. 1 are shown in RAM (168), but many components of such software typically are stored in non-volatile memory also, such as, for example, on a disk drive (170).

The system management server (152) of FIG. 1 includes disk drive adapter (172) coupled through expansion bus (160) and bus adapter (158) to processor (156) and other components of the system management server (152). Disk drive adapter (172) connects non-volatile data storage to the system management server (152) in the form of disk drive (170). Disk drive adapters useful in computers for dynamic collection of system support files in a data processing environment according to embodiments of the present invention include Integrated Drive Electronics ('IDE') adapters, Small Computer System Interface (SCSI') adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example system management server (152) of FIG. 1 includes one or more input/output ('I/O′) adapters (178). I/O adapters implement user-oriented input/output through, for example, software drivers and computer hardware for controlling output to display devices such as computer display screens, as well as user input from user input devices (181) such as keyboards and mice. The example system management server (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example system management server (152) of FIG. 1 includes a communications adapter (167) for data communications with other computers (182) and for data communications with a data communications network (100). Such data communications may be carried out serially through RS-232 connections, through external buses such as a Universal Serial Bus ('USB'), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for dynamic collection of system support files in a data processing environment according to embodiments of the present invention include modems for wired dial-up communications, Ethernet (IEEE 802.3) adapters for wired data communications network communications, and 802.11 adapters for wireless data communications network communications.

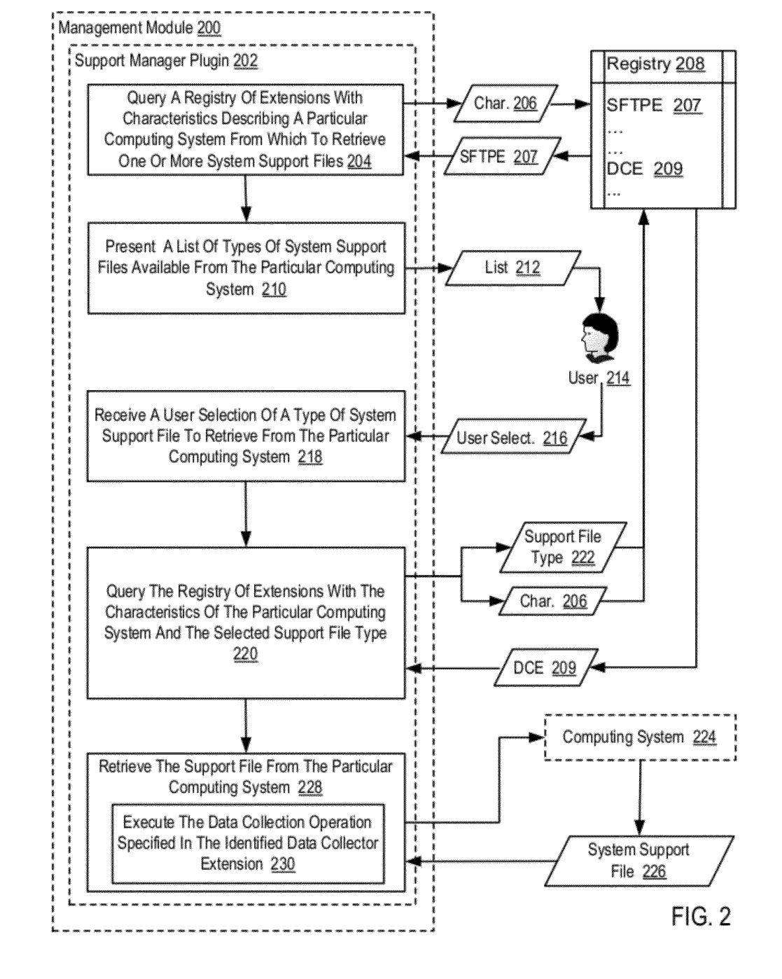

For further explanation, FIG. 2 sets forth a flow chart illustrating an example method for dynamic collection of system support files in a data processing environment according to embodiments of the present invention. The data processing environment within which dynamic collection of system support files is carried out in accordance with the method of FIG. 2 includes a management module and a plurality of computing systems, where a number of those computing systems have different characteristics.

In the example of FIG. 2, the management module (200) may be implemented as automated computing machinery for monitoring computing systems. The management module (200) may include computer program instructions executing on computer hardware that monitor the health and performance of a computing system (224). The management module (200) may monitor, for example, the amount of power being consumed by the computing system (224), the number of jobs being serviced by the computing system (224) per unit of time, the amount of data communications traffic flowing into and out of by the computing system (224), errors conditions within the computing system (224), the health of individual components within the computing system (224), and so on.

In the example of FIG. 2, the management module (200) includes a support manager plugin (202). In the example of FIG. 2, the support manager plugin (202) is automated computing machinery for providing specific capabilities and functionality to the management module (200). The support manager plugin (202) of FIG. 2 may be embodied as computer program instructions executing on computer hardware that provide specific capabilities and functionality to the management module (200). For example, the support manager plugin (202) of FIG. 2 may include computer program instructions that enable the management module (200) to determine what type of support information, such as an error log, a core dump, or other support information is available from a computing system (224) that is being monitored by the management module (200).

The method of FIG. 2, includes querying (204), by the support manager plugin (202) of the management module (200), a registry (208) of extensions with characteristics (206) describing a particular computing system (224) from which to retrieve one or more system support files (226). Such characteristics (206) may include, for example, an identification of an operating system that is running on the computing system (224), an identification of the instruction set architecture of a processor in the computing system (224), a model number of the computing system (224), and so on. In the example of FIG. 2, querying (204) the registry (208) of extensions with characteristics (206) describing a particular computing system from which to retrieve one or more system support files may be carried out, for example, by searching the registry (208) for a support file type provider extension (207) that includes computing system characteristics that match the particular computing system's characteristics.

In the example of FIG. 2, the registry (208) of extensions is a data structure such as, for example, a table, a list, or other data structures that includes one or more extensions. In the example of FIG. 2, the registry (208) includes a support file type provider extension (207). A support file type provider extension (207) represents a specification of a particular computing system (224) along with an identification of the system support files that are generated by the computing system (224)—support files that can be retrieved by the management module (200) for use in monitoring the computing system (224). Consider the following example of a support file type provider extension (207):

<extension extensionidentifier=“datacollections.supportfiletypeprovider”>

<supportfileprovider>

class=“supportfiles.SystemXSupportFileProvider”
architecture=“x86, x86_64, x64”
osname=“ALL”
vendor=“IBM”>

</supportfileprovider>

</extension>

In this example, the support file type provider extension (207) is specified in a markup language. The support file type provider extension (207) includes an attribute name ‘extensionidentifier’ that identifies the support file type provider extension (207). The support file type provider extension (207) also includes a ‘supportfileprovider’ element that identifies a class, or other set of computer program instructions, that can generate a list of support file types that are available from a computing system with the characteristics identified in the ‘supportfileprovider’ element.

In this example, the ‘supportfileprovider’ element includes an attribute named ‘class’ that identifies a particular class, such as a Java™ class, responsible for generating a list of support file types that are available from a computing system with the characteristics identified in the support file type provider extension (207). In this example, such characteristics are identified in the ‘supportfileprovider’ element, which includes three attributes describing characteristics of a computing system: the ‘architecture’ element that identifies an instruction set architecture; the ‘osname’ element that identifies an operating system; and the ‘vendor’ element that identifies a vendor.

In such an example, a computing system (224) characterized by an instruction set architecture, an operating system, and a vendor identification that matches the characteristics contained in the support file type provider extension (207) can generate support files. The list of support files generated by such a computing system (224) can be provided by the class identified in the ‘class’ attribute. Each support file type provider extension (207) therefore includes, through the identified class, one or more types of system support files available for retrieval from computing systems having a predefined set of characteristics.

The example of FIG. 2 also includes presenting (210), by the support manager plugin (202) to a user (214), a list (212) of types of system support files (226) available from the particular computing system (224). In the example of FIG. 2, the list (212) of types of system support files (226) available from the particular computing system (224) may be presented to the user (214), for example, via a graphical user interface (GUI') delivered to the user (214) via a computer, mobile device, or other display device. The list (212) of types of system support files (226) available from the particular computing system (224) may be retrieved, for example, using the returned support file type provider extension (207), which includes a class, or other set of computer program instructions, that can generate a list of support file types that are available from a computing system (224) with the characteristics identified in the returned support file type provider extension (207).

The example of FIG. 2 also includes receiving (218), by the support manager plugin (202), a user selection (216) of a type of system support file to retrieve from the particular computing system (224). Receiving (218), by the support manager plugin (202), a user selection (216) of a type of system support file to retrieve from the particular computing system (224) may be carried out by receiving a message generated by the GUI that delivers the list (212) of types of system support files (226) available from the particular computing system (224) to the user (214). For example, the user (214) may select certain types of system support files (226) available from the particular computing system (224) using the GUI and such a selection may be delivered to the support manager plugin (202) from the GUI.

The example of FIG. 2 also includes querying (220), by the support manager plugin (202), the registry (208) of extensions for a data collector extension (209). In the example of FIG. 2, the registry (208) includes, in addition to the support file type provider extensions (207) described above, a data collector extension (209). A data collector extension (209) represents a specification of a data collection operation to retrieve a system support file (226) from the particular computing system (224)—a system support file (226) that can be used by the management module (200) for use in monitoring the computing system (224). Consider the following example of a data collector extension (209):

<extension name = ″Data Collector Extension for Linux OS”
extensionidentifier = ″datacollection.datacollector″>

<collector

description=″Data Collector Extension for Linux OS″

</collector>
<command

cmdlocation=″/Linux.bin″

</command>
<output

description=″Extended error data directory″
location=″/supportfiles″>

</output>

</extension>

In this example, the data collector extension (209) is specified in a markup language. The data collector extension (209) includes an identifier, description, and a specification of a command, including the location of the command, that represents a specification of a data collection operation to retrieve a system support file (226) from the particular computing system (224). In this example, the data collector extension (209) also includes an output location that identifies the location to which the retrieved system support file (226) should be stored.

In the example of FIG. 2, the registry (208) of extensions is queried (220) with the characteristics (206) of the particular computing system (224) and the selected support file type (222) for a data collector extension (209). In the example of FIG. 2, querying (220) the registry (208) of extensions with the characteristics (206) of the particular computing system (224) and the selected support file type (222) for a data collector extension (209) may be carried out, for example, by searching the registry (208) for a data collector extension (209) that includes computing system characteristics matching the characteristics of the particular computing system and that includes support file types matching the selected support file type (222).

The example of FIG. 2 also includes retrieving (228), by the support manager plugin (202), the system support file (226) from the particular computing system (224), including executing (230) the data collection operation specified in the identified data collector extension (209). As described above, the data collector extension (209) identifies a data collection operation to retrieve a system support file (226) from the particular computing system (224). In order to retrieve such a system support file (226), the support manager plugin (202) may execute (230) the data collection operation to retrieve a system support file (226) from the particular computing system (224), for example, through an API that exposes the data collection operation on the particular computing system (224) to the support manager plugin (202).

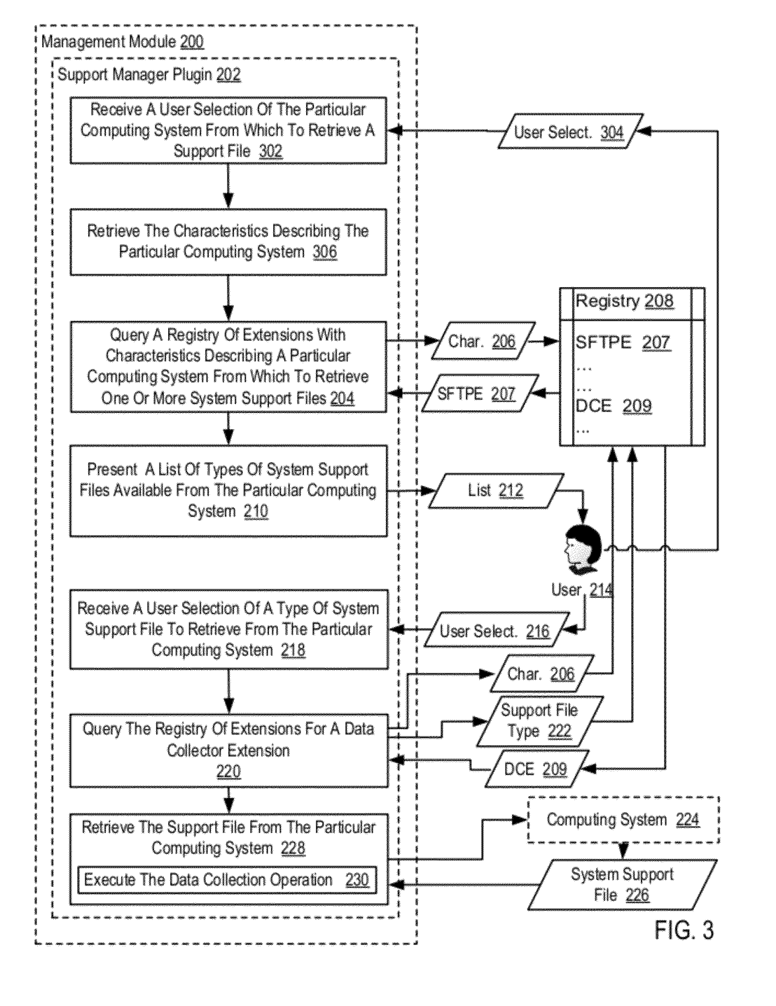

For further explanation, FIG. 3 sets forth a flow chart illustrating a further example method for dynamic collection of system support files in a data processing environment according to embodiments of the present invention. The example of FIG. 3 is similar to the example of FIG. 2 as it also includes:
Querying (204), by a support manager plugin (202) of a management module (200), a registry (208) of extensions with characteristics (206) describing a particular computing system (224) from which to retrieve one or more system support files (226) for a support file type provider extension (207),
Presenting (210), by the support manager plugin (202) to a user (214), a list (212) of types of system support files (226) available from the particular computing system (224),
Receiving (218), by the support manager plugin (202), a user selection (216) of a type of system support file (226) to retrieve from the particular computing system (224),
Querying (220), by the support manager plugin (202), the registry (208) of extensions with the characteristics (206) of the particular computing system (224) and the selected support file type (222) for a data collector extension (209), and
Retrieving (228), by the support manager plugin (202), the system support file (226) from the particular computing system (224), including executing (230) the data collection operation specified in the identified data collector extension (209).

The example of FIG. 3 also includes receiving (302), by the support manager plugin (202), a user selection (304) of the particular computing system (224) from which to retrieve a system support file (226). In the example of FIG. 3, a user (214) may be interested in monitoring a particular computing system (224). As such, the user (214) may select a particular computing system (224) from which to retrieve a system support file (226). In such an example, the user (214) may be presented with a list of computing systems from which system support files are available via a GUI. The user (214) may subsequently select a particular computing system (224) from which to retrieve a system support file (226) by selecting an option presented in the GUI. Receiving (302), by the support manager plugin (202), a user selection (304) of the particular computing system (224) from which to retrieve a system support file (226) may therefore be carried out by the support manager plugin (202) receiving a message from the GUI that includes a user selection (304) identifying the particular computing system (224) from which to retrieve a system support file (226).

The example of FIG. 3 also includes retrieving (306), by the support manager plugin (202) from the particular computing system (224), the characteristics (206) describing the particular computing system (224). In the example of FIG. 3, the support manager plugin (202) may retrieve (306) the characteristics (206) describing the particular computing system (224), for example, by sending a request for such information to the computing system (224) itself, by searching a characteristic repository that contains characteristics for a plurality of computing systems, and so on.

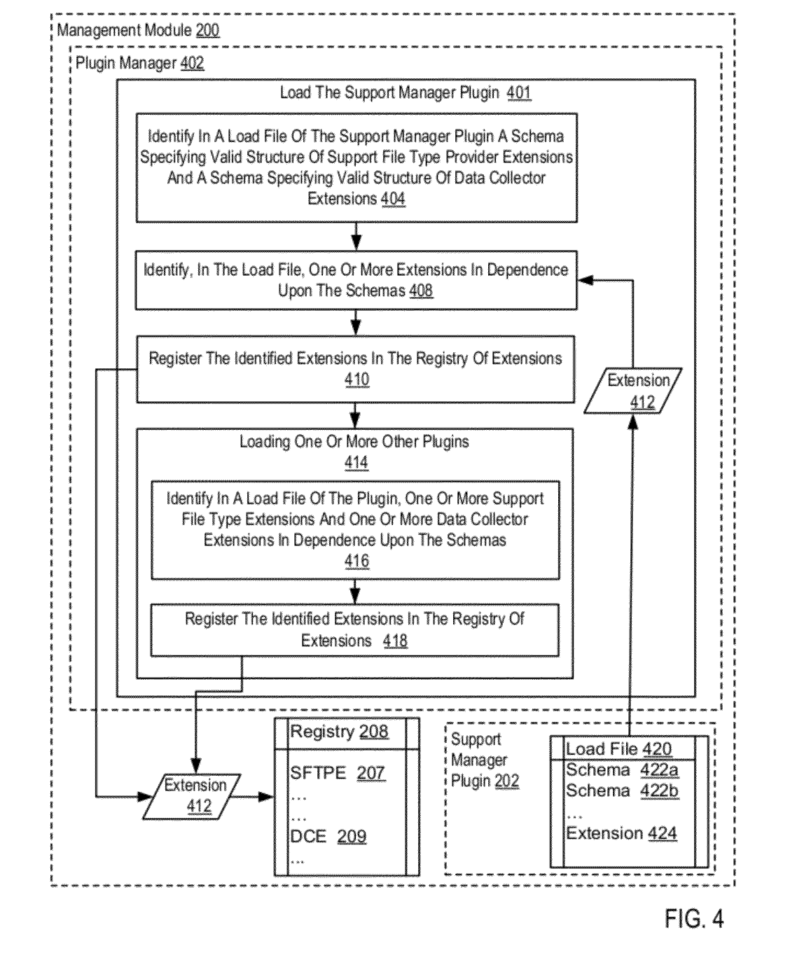

For further explanation, FIG. 4 sets forth a flow chart illustrating an example method for loading (401), by a plugin manager (402), the support manager plugin (202) for execution in the management module (200) for use in dynamic collection of system support files in accordance with embodiments of the present invention. That is, FIG. 4 sets forth a method related to the method of FIG. 2 in that the method of FIG. 4 may be carried out prior to the method of FIG. 2 at start-up of the management module (200), establishing or populating the registry (208), prior to support manager plugin (202) operation described in the method of FIG. 2.

In the example of FIG. 4, the plugin manager (402) is a module of automated computing machinery for installing, uninstalling, and monitoring plugins installed on the management module (202), including the support manager plugin (202). The plugin manager (402) may be embodied, for example, as computer program instructions executing on computer hardware.

In the example of FIG. 4, loading (401) the support manager plugin (202) for execution in the management module (200) includes identifying (404) in a load file (420) of the support manager plugin (202) a schema (422a) specifying valid structure of support file type provider extensions and a schema (422b) specifying valid structure of data collector extensions. In the example of FIG. 4, the load file (420) is a data structure that includes at least one schema for at least one extension. In the example of a FIG. 4, each schema (422a, 422b) may be embodied, for example, as a markup document that includes markup similar to the example markup illustrated above. Each schema (422a, 422b) identifies an extension, such as a support file type provider extension or a data collector extension, and all of its components.

In the example of FIG. 4, loading (401) the support manager plugin (202) for execution in the management module (200) includes identifying (408), in the load file (420), one or more extensions (424) in dependence upon the schemas (422a, 422b). In the example of FIG. 4, identifying (408) one or more extensions (424) in dependence upon the schemas (422a, 422b) may be carried out, for example, by parsing markup representing a particular schema (422a, 422b) to identify a portion of the markup that specifies an identifier for an extension (424), a description of the extension (424), an identification of source code for executing the functionality of the extension (424), and so on.

In the example of FIG. 4, loading (401) the support manager plugin (202) for execution in the management module (200) includes registering (410) the identified extensions (424) in the registry (208) of extensions. In the example of FIG. 4, registering (410) the identified extensions (424) in the registry (208) of extensions can be carried out, for example, by creating an entry in the registry (208) of extensions for the identified extensions (424). In an example in which the schemas (422a, 422b) are embodied as markup, registering (410) the identified extensions (424) in the registry (208) of extensions may include copying the schema (422a, 422b) into the registry (208) of extensions—copying the markup into the registry (208). Registering (410) the identified extensions (424) in the registry (208) of extensions may alternatively be carried out, for example, by extracting information from the schema (422a, 422b) and inserting such information into an extension template that is subsequently stored in the registry (208) of extensions.

The example of FIG. 4 also includes loading (414) one or more other plugins. The ability to load additional plugins other than the support manager plugin (202) creates an extensible framework for customizing the management module (200) in which multiple contributors can create multiple plugins that are added to the management module (200), thereby expanding the capabilities of the management module (200). In the example of FIG. 4, loading (414) one or more other plugins can include, for each plugin, identifying (416) in a load file of the plugin, one or more support file type extensions, and one or more data collector extensions in dependence upon the schemas and registering (418) the identified extensions in the registry of extensions. The process for loading (414) one or more other plugins is therefore similar in nature to the process for loading the support manager plugin (202) that was described above.

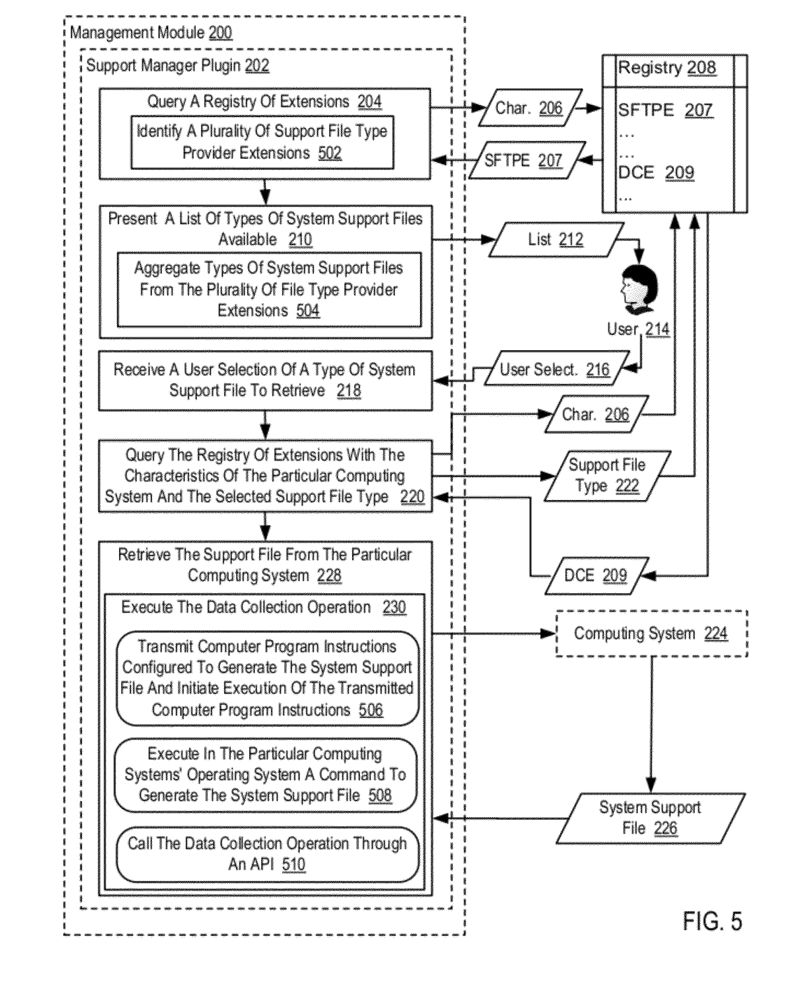

For further explanation, FIG. 5 sets forth a flow chart illustrating a further example method for dynamic collection of system support files in a data processing environment according to embodiments of the present invention. The example of FIG. 5 is similar to the example of FIG. 2 as it also includes:
Querying (204), by a support manager plugin (202) of a management module (200), a registry (208) of extensions with characteristics (206) describing a particular computing system (224) from which to retrieve one or more system support files (226) for a support file type provider extension (207),
Presenting (210), by the support manager plugin (202) to a user (214), a list (212) of types of system support files (226) available from the particular computing system (224),
Receiving (218), by the support manager plugin (202), a user selection (216) of a type of system support file (226) to retrieve from the particular computing system (224),
Querying (220), by the support manager plugin (202), the registry (208) of extensions with the characteristics (206) of the particular computing system (224) and the selected support file type (222) for a data collector extension (209), and
Retrieving (228), by the support manager plugin (202), the system support file (226) from the particular computing system (224), including executing the data collection operation specified in the identified data collector extension (209).

In the example of FIG. 5, however, querying (204) the registry (208) for a support file type provider extension (207) includes identifying (502) a plurality of support file type provider extensions. In some embodiments the support manager plugin queries the registry for a single support file type provider extension, but in the example of FIG. 5, the support manager plugin may retrieve as many support file type provider extensions as are available in the registry for computing systems having characteristics that match the particular computing systems characteristics (206). Consider an example set of computing characteristics for which multiple support file type provider extension may be present in the registry (208): an x86 model_XXY server, running Windows XP, with an ABC type service processor. For this example set of computing system characteristics, the registry may include any of the following a support file type provider extensions:
an extension for x86 computing systems;
an extension for x86 computing systems running Windows™ XP operating system;
an extension for model_XXY servers;
an extension for x86, model_XXY servers;
an extension for model_XXY servers with an ABC type service processor; and
an extension for computing systems having an ABC type service processor,

Rather than identifying only one of these example support file type provider extensions, the method of FIG. 5 includes identifying (502) a plurality of the extensions. The identified plurality of support file type provider extensions, however, may include overlapping specifications of support file types—that is, any two of the identified support file type provider extensions may specify the same support file type. Rather than presenting duplicate system support file types to the user, presenting (210) a list (212) of types of system support files in the method of FIG. 5 includes aggregating (504) types of system support files from the plurality of file type provider extensions (207). In the example of FIG. 5, aggregating (504) types of system support files from the plurality of file type provider extensions (207) may carried out, for example, by adding, from each of the identified support file type provider extensions, each unique system support file type—without duplicating system support file types in the list (212).

In the example of FIG. 5, executing (230) the data collection operation specified in the identified data collector extension (209) can include transmitting (506), to the particular computing system (224), computer program instructions configured to generate the system support file and initiating execution of the transmitted computer program instructions by the particular computing system (224). In the example of FIG. 5, transmitting (506), to the particular computing system (224), computer program instructions configured to generate the system support file and initiating execution of the transmitted computer program instructions by the particular computing system (224) may be carried out in a variety of ways such as, for example, by transmitting a simple executable file that is executed by the by the particular computing system (224), by transmitting an installation bundle that installs an API on the particular computing system (224) that exposes functions on the particular computing system (224) to the support manager plugin (202), by transmitting a JAR file to the particular computing system (224) that includes data collection operations, and in other ways as will occur to those of skill in the art.

In the example of FIG. 5, executing (230) the data collection operation specified in the identified data collector extension (209) can alternatively include executing (508) in the operating system of the particular computing systems (204) a command to generate the system support file. Executing (508) in the operating system of the particular computing systems (204) a command to generate the system support file may be carried out, for example, by calling an OS core dump command.

In the example of FIG. 5, executing (230) the data collection operation specified in the identified data collector extension (209) can alternatively include calling (510) the data collection operation through an API that exposes operations the particular computing system (224) to the support manager plugin (202). In the example of FIG. 5, each monitored computing system (224) may include an API exposing data collection operations to the management module (200) and various plugins in the management module (200), such as the support manager plugin (202). In such an example, the support manager plugin (202) may call a data collection operation that is exposed to the support manager plugin (202) via the API.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the present invention may also be delivered as part of a service engagement with a client corporation, nonprofit organization, government entity, internal organizational structure, or the like. Aspects of these embodiments may include configuring a computer system to perform, and deploy software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of dynamic collection of system support files in a data processing environment, the data processing environment comprising a plurality of computing systems, a plurality of the computing systems having different characteristics, the method comprising:
querying, by a support manager plugin of a management module, a registry of extensions with characteristics describing a particular computing system from which to retrieve one or more system support files for a support file type provider extension, each support file type provider extension comprising one or more types of system support files available for retrieval from computing systems having a predefined set of characteristics;
presenting, by the support manager plugin to a user, a list of types of system support files available from the particular computing system;
receiving, by the support manager plugin, a user selection of a type of system support file to retrieve from the particular computing system;
querying, by the support manager plugin, the registry of extensions with the characteristics of the particular computing system and the selected support file type for a data collector extension, each data collector extension comprising a specification of a data collection operation to retrieve the system support file from the particular computing system; and
retrieving, by the support manager plugin, the system support file from the particular computing system, including executing the data collection operation specified in the identified data collector extension.

2. The method of claim 1, further comprising:
receiving, by the support manager plugin, a user selection of the particular computing system from which to retrieve a support file; and
retrieving, by the support manager plugin from the particular computing system, the characteristics describing the particular computing system.

3. The method of claim 1, further comprising:
loading, by a plugin manager, for execution in the management module, the support manager plugin, including:
identifying in a load file of the support manager plugin a schema specifying valid structure of support file type provider extensions and a schema specifying valid structure of data collector extensions;
identifying, in the load file, one or more extensions in dependence upon the schemas; and
registering the identified extensions in the registry of extensions.

4. The method of claim 1, further comprising loading one or more other plugins including, for each plugin:
identifying in a load file of the plugin, one or more support file type extensions and one or more data collector extensions in dependence upon the schemas; and
registering the identified extensions in the registry of extensions.

5. The method of claim 1 wherein:
querying the registry for a support file type provider extension further comprises identifying a plurality of support file type provider extensions; and
presenting a list of types of system support files available from the particular computing system further comprises aggregating types of system support files from the plurality of file type provider extensions.

6. The method of claim 1 wherein executing the data collection operation specified in the identified data collector extension further comprises transmitting, to the particular computing system, computer program instructions configured to generate the system support file and initiating execution of the transmitted computer program instructions by the particular computing system.

7. The method of claim 1 wherein executing the data collection operation specified in the identified data collector extension further comprises executing in the particular computing systems' operating system a command to generate the system support file.

8. The method of claim 1 wherein executing the data collection operation specified in the identified data collector extension further comprises calling the data collection operation through an API that exposes operations on the particular computing system to the support manager plugin.

9. Apparatus for dynamic collection of system support files in a data processing environment, the apparatus comprising a computer processor, a computer memory operatively coupled to the computer processor, the computer memory having disposed within it computer program instructions that, when executed by the computer processor, cause the apparatus to carry out the steps of:
querying, by a support manager plugin of a management module, a registry of extensions with characteristics describing a particular computing system from which to retrieve one or more system support files for a support file type provider extension, each support file type provider extension comprising one or more types of system support files available for retrieval from computing systems having a predefined set of characteristics;
presenting, by the support manager plugin to a user, a list of types of system support files available from the particular computing system;
receiving, by the support manager plugin, a user selection of a type of system support file to retrieve from the particular computing system;
querying, by the support manager plugin, the registry of extensions with the characteristics of the particular computing system and the selected support file type for a data collector extension, each data collector extension comprising a specification of a data collection operation to retrieve the system support file from the particular computing system; and
retrieving, by the support manager plugin, the system support file from the particular computing system, including executing the data collection operation specified in the identified data collector extension.

10. The apparatus of claim 9 further comprising computer program instructions that, when executed by the computer processor, cause the apparatus to carry out the steps of:
receiving, by the support manager plugin, a user selection of the particular computing system from which to retrieve a support file; and
retrieving, by the support manager plugin from the particular computing system, the characteristics describing the particular computing system.

11. The apparatus of claim 9 further comprising computer program instructions that, when executed by the computer processor, cause the apparatus to carry out the step of:
loading, by a plugin manager, for execution in the management module, the support manager plugin, including:
identifying in a load file of the support manager plugin a schema specifying valid structure of support file type provider extensions and a schema specifying valid structure of data collector extensions;
identifying, in the load file, one or more extensions in dependence upon the schemas; and
registering the identified extensions in the registry of extensions.

12. The apparatus of claim 9 further comprising computer program instructions that, when executed by the computer processor, cause the apparatus to carry out the step of loading one or more other plugins including, for each plugin:
identifying in a load file of the plugin, one or more support file type extensions and one or more data collector extensions in dependence upon the schemas; and
registering the identified extensions in the registry of extensions.

13. The apparatus of claim 9 wherein:
querying the registry for a support file type provider extension further comprises identifying a plurality of support file type provider extensions; and
presenting a list of types of system support files available from the particular computing system further comprises aggregating types of system support files from the plurality of file type provider extensions.

14. The apparatus of claim 9 wherein executing the data collection operation specified in the identified data collector extension further comprises transmitting, to the particular computing system, computer program instructions configured to generate the system support file and initiating execution of the transmitted computer program instructions by the particular computing system.

15. The apparatus of claim 9 wherein executing the data collection operation specified in the identified data collector extension further comprises executing in the particular computing systems' operating system a command to generate the system support file.

16. The apparatus of claim 9 wherein executing the data collection operation specified in the identified data collector extension further comprises calling the data collection operation through an API that exposes operations on the particular computing system to the support manager plugin.

17. A computer program product for dynamic collection of system support files in a data processing environment, the computer program product disposed upon a computer readable storage medium, the computer program product comprising computer program instructions that, when executed, cause a computer to carry out the steps of:
querying, by a support manager plugin of a management module, a registry of extensions with characteristics describing a particular computing system from which to retrieve one or more system support files for a support file type provider extension, each support file type provider extension comprising one or more types of system support files available for retrieval from computing systems having a predefined set of characteristics;
presenting, by the support manager plugin to a user, a list of types of system support files available from the particular computing system;
receiving, by the support manager plugin, a user selection of a type of system support file to retrieve from the particular computing system;
querying, by the support manager plugin, the registry of extensions with the characteristics of the particular computing system and the selected support file type for a data collector extension, each data collector extension comprising a specification of a data collection operation to retrieve the system support file from the particular computing system; and
retrieving, by the support manager plugin, the system support file from the particular computing system, including executing the data collection operation specified in the identified data collector extension

18. The computer program product of claim 17 further comprising computer program instructions that, when executed, cause a computer to carry out the steps of:
receiving, by the support manager plugin, a user selection of the particular computing system from which to retrieve a support file; and
retrieving, by the support manager plugin from the particular computing system, the characteristics describing the particular computing system.

19. The computer program product of claim 17 further comprising computer program instructions that, when executed, cause a computer to carry out the step of:
loading, by a plugin manager, for execution in the management module, the support manager plugin, including:
identifying in a load file of the support manager plugin a schema specifying valid structure of support file type provider extensions and a schema specifying valid structure of data collector extensions;
identifying, in the load file, one or more extensions in dependence upon the schemas; and
registering the identified extensions in the registry of extensions.

20. The computer program product of claim 17 further comprising computer program instructions that, when executed, cause a computer to carry out the step of loading one or more other plugins including, for each plugin:
identifying in a load file of the plugin, one or more support file type extensions and one or more data collector extensions in dependence upon the schemas; and
registering the identified extensions in the registry of extensions.

21. The computer program product of claim 17 wherein:
querying the registry for a support file type provider extension further comprises identifying a plurality of support file type provider extensions; and
presenting a list of types of system support files available from the particular computing system further comprises aggregating types of system support files from the plurality of file type provider extensions.

22. The computer program product of claim 17 wherein executing the data collection operation specified in the identified data collector extension further comprises transmitting, to the particular computing system, computer program instructions configured to generate the system support file and initiating execution of the transmitted computer program instructions by the particular computing system.

23. The computer program product of claim 17 wherein executing the data collection operation specified in the identified data collector extension further comprises executing in the particular computing systems' operating system a command to generate the system support file.

24. The computer program product of claim 17 wherein executing the data collection operation specified in the identified data collector extension further comprises calling the data collection operation through an API that exposes operations on the particular computing system to the support manager plugin.
